(19) United States
(12) Patent Application Publication
(10) Pub. No.: US 2010/0313176 A1
(43) Pub. Date: Dec. 9, 2010

(54) DELAY LIBRARY, DELAY LIBRARY CREATION METHOD, AND DELAY CALCULATION METHOD

(76) Inventors: Masao Takahashi, Osaka (JP); Kazuhiro Satoh, Osaka (JP); Noriko Ishibashi, Osaka (JP); Naoki Amekawa, Kyoto (JP)

Correspondence Address: MCDERMOTT WILL & EMERY LLP, 600 13TH STREET, NW, WASHINGTON, DC, 20005-3096, US

(21) Appl. No.: 12/743,965

(22) PCT Filed: Feb. 24, 2009
(86) PCT No.: PCT/JP2009/000786

§ 371 Date: May 20, 2010

(30) Foreign Application Priority Data
Jul. 8, 2008 (JP) 2008-177593

(51) Int. Cl. G06F 9/455

(52) U.S. Cl. 716/108

(57) ABSTRACT

A timing window (TW) representing a time zone where a signal transition possibly occurs in a time axis is generated for each of input signals in input terminals in a multi-input logic cell based on a signal transition timing in each of the input terminals. An overlap between the timing windows (TW) of input signals is detected, and a circuit delay time is calculated by selectively using one of a synchronous transition time and an asynchronous transition time in accordance with the overlap between the timing windows (TW). These processing steps are sequentially repeated to eliminate an optimistic or pessimistic analysis in the calculation of delay times in the multi-input logic cell.

### FIELD OF THE INVENTION

The present invention relates to a method for improving an analyzing accuracy by more accurately expressing signal propagation times (delay times) in a semiconductor integrated circuit for practical use during post-layout timing verification carried out in a layout design, or the final phase of the circuit design.

### DESCRIPTION OF THE RELATED ART

As the miniaturization of a semiconductor manufacturing process advances in recent years, logic elements constituting a circuit and wiring connecting the logic elements are increasingly affected by parasitic capacitance and parasitic resistance. Under the circumstances, connection information of the logical elements alone no longer serves the purpose of accurately predicting signal propagation times generated in the whole circuit, making it vital to provide a timing verification considering values of wiring resistance and wiring capacitance obtained after the layout design of the circuit. Another ongoing issue resulting from the miniaturization is a larger impact of variability between the processes, and the impact is conventionally taken into account as a design margin.

The timing verification eventually decides if a target design specification is met by calculating times necessary for signal propagation (hereinafter, referred to as cell delay time) in circuit elements (multi-input logic cells and wiring) using information of parasitic resistance and parasitic capacitance of wiring connecting multi-input logic cells as well as connection information of the multi-input logic cells.

In the conventional timing verification available for a semiconductor integrated circuit, delay times generated in the whole circuit are calculated by using a circuit simulator such as a SPICE simulator prior to the timing verification. To analyze the circuit-level delay times using a circuit simulator, which is known as a time-consuming approach, may be used in small circuits but is inapplicable to large circuits in view of an acceptable range of actual processing time.

To timing-verify any large circuits, therefore, a gate-level timing verification is conventionally employed. Describing the gate-level timing verification, as a prior step, cell delay times from input terminals to output terminals and characteristic values (for example, tilt information of voltage waveform in output terminals, power consumption) are extracted (characterized) by, for example, a SPICE simulator for each of the logic elements constituting an integrated circuit, and the extracted values are put together into a database and used as a delay library. In the delay library, the obtained values are tabulated so that the cell delay times are associated with the characteristic values. In the description given below, the database containing the tabulated cell delay times is called a cell delay time table. Referring to the values stored in the delay library, the cell delay times are identified in association with the respective circuit elements (multi-input logic cells, wiring), and the cell delay times thus identified are summed one by one, so that a total delay time in the whole circuit (hereinafter, referred to as gate-level delay time) is calculated. The gate-level timing verification is carried out based on the gate-level delay time.

It is a technical common knowledge to the skilled in the art that some of the logic cells constituting a circuit have a plurality of input terminals (hereinafter, referred to as “multi-input logic cells”), wherein a cell delay time from one of the plurality of input terminals (terminal which is a characterizing target) to an output cell varies depending on a status (in synchronous transition or fixed to “0” or “1”) of any other input terminal (terminal which is not a characterizing target).

To characterize the multi-input logic cell, an input signal of any non-characterized terminal is mostly fixed to “0” or “1.” In some cases, the transition of an input signal of a non-characterizing input terminal is set beforehand to be synchronous with the transition of an input signal of the terminal to be characterized.

To characterize the multi-input logic cell, the input signal of the non-characterizing input terminal is thus fixed to a particular single pattern beforehand, and the target logic cell is then subjected to a characterization process. When the gate-level delay time in a circuit provided with a plurality of multi-input logic cells is calculated, therefore, a gate-level delay time in total is calculated based on the delay times of the plurality of multi-input logic cells wherein:
the input signals of any input terminals irrelevant to the cell operation are fixed to “0” or “1”; or
the input signals of any input terminals irrelevant to the cell operation transit synchronously.

In the timing verification for a large circuit (integrated circuit), therefore, the cell delay times of the multi-input logic cell are different to cell delay times of the multi-input logic cell in an actual operation in the stage of creating the delay library.

As a conventional method for calculating the gate-level delay time that successfully eliminated such an inconvenience (impact of the variability in the cell delay times in the multi-input logic cell in accordance with the transition of the input signals in the input terminals), there is a transistor-level delay time calculation method for calculating a maximum or minimum cell delay time or such a cell delay time that complies with an actual operation by providing a way of setting the input signal of the non-characterizing input terminal affecting the cell delay time (see Patent Document 1).

According to the conventional example thus improved (hereinafter, this example is referred to as a second conventional example, and the conventional example described earlier is referred to as a first conventional example), when a delay time of a particular signal propagation path in a whole circuit including other input terminals (hereinafter, referred to as a particular path) is calculated by using a transistor-level circuit simulator such as SPICE, input timings of input signals of any input terminals of a multi-input logic cell other than those on the particular path are determined so that delay times on the particular path (cell delay times in the multi-input logic cell on the particular path) are maximized or minimized, and a gate-level delay time in each transistor is then calculated.

### Patent Document 1: WO2004-079600

### DISCLOSURE OF THE INVENTION

### Problem to be Solved by the Invention

As the miniaturization of a semiconductor manufacturing process advances in recent years, variability between processes increases. The variability is so wide that if it is accepted as a design margin it would jeopardize the completion of a device design. To avoid any unwanted timing correction, it is necessary to reduce a design margin and decrease optimism and pessimism during the calculation of a gate-level delay time and timing verification. The pessimism refers to the fact that a path determined by the timing verification as violating timing constraints still has some timing margin in a practical circuit operation. Therefore, a pessimistic analysis may possibly determine any path for which timing correction is practically unnecessary as a path violating the constraints. The optimism refers, on the other hand, to the fact that a path which complies with constraints according to its timing verification result fails to meet the constraints in a real circuit operation. An optimistic analysis may result in malfunction in a real circuit.

The second conventional example is effective in decreasing the optimism and pessimism to be shown in the delay calculation and timing verification in a transistor-level simulation of a circuit including multi-input logic cells, whereas the transistor-level simulation needs an enormous amount of processing time. Therefore, it is not a realistic approach to use the second conventional example for the calculation of an overall delay time (gate-level delay time) in any large integrated circuits.

To calculate the gate-level delay time in a circuit including multi-input logic cells, consideration is given to only the state in which the input signal of a non-characterizing input terminal is fixed to “0” or “1” as described in the first conventional example. Therefore, the calculation of the gate-level delay time still depends on the signal input timings in the input terminals of the multi-input logic cell in the stage of creating the delay library, with no consideration given to impacts of the cell delay time variability. For example, as illustrated in FIG. 17A, a cell delay time generated when a signal is transmitted from an input terminal A to an output terminal Y in a 2-input NAND (input terminals A and B, output terminal Y) results in different calculation values depending on whether the signal is inputted to the input terminal B at the same time as inputted to the input terminal A or the input signal of the input terminal B is fixed to “1.” As a result, different waveforms are generated in the output terminal Y. When a rising waveform is inputted to the input terminal A and a falling waveform is outputted to the output terminal Y as illustrated in FIG. 17B, n-ch transistors longitudinally loaded in the NAND cell synchronously start their operations, increasing the cell delay times. On the other hand, when the falling waveform is inputted to the input terminal A and the rising waveform is outputted to the output terminal Y as illustrated in FIG. 17C, parallel p-ch transistors in the NAND cell, synchronously start their operations, decreasing the cell delay times. When the parallel p-ch transistors synchronously operate, in particular, a current flow is doubled in the 2-input NAND cell, reducing the cell delay times to approximately ½. Thus, the synchronous operation generates a large impact, and reduction of the delay times is more evident as the input terminals are increased. The cell delay times may be reduced to approximately ⅓ in a multi-input logic cell having three inputs, and approximately ¼ in a multi-input logic cell having four inputs.

The calculation of the gate-level delay time using the delay library thus created (cell delay time table) similarly depends on the signal input timings in the input terminals of the multi-input logic cell, with no consideration given to impacts of the cell delay time variability. In the gate-level delay time calculation and timing verification in the whole path including the multi-input logic cells, therefore, a simulation result thereby obtained may present a delay time shorter or longer than an actual gate-level delay time.

FIG. 16 illustrates a relationship between a cell delay time (longitudinal axis) shown when a signal is transmitted from an input terminal A to an output terminal Y and an input transition timing difference (lateral axis) between the input terminal A and the input terminal B, in a 2-input NAND (input terminals A and B, output terminal Y). The input transition timing difference denotes a shift between the input signals of the input terminals A and B. As illustrated in FIG. 16, a calculation value of the cell delay time possibly has a several-fold difference depending on whether the transitions of the input signals synchronously occur, i.e., input transition timing difference is zero or their transitions do not occur synchronously. This difference leads to calculation errors.

As described so far, the underlying problem of the conventional gate-level delay time calculation is the failure to take into account the impact posed on the delay times by the input transition timing difference in the input terminals of the multi-input logic cell, and the undue optimism and pessimism remain unresolved in the gate-level delay time calculation and timing verification.

### Means for Solving the Problem

To solve the conventional problem, the present invention provides a method for considering signal input timings in input terminals of a multi-input cell when a gate-level delay time is calculated. More specifically, the present invention provides a delay library creation method and a delay calculation method for avoiding optimistic and pessimistic timing verifications.

According to the present invention, a plurality of patterns that may impact on a delay time depending on a voltage transition timing in a terminal are extracted from inputted connection information of a transistor, a multi-input logic cell is then characterized based on the extracted and inputted plurality of patterns, and a characterizing result based on the plurality of patterns is registered as a delay library.

As a result, delay value information of two patterns, which are a pattern in the case where synchronous transition occurs in other terminals and a pattern in the case where synchronous transition does not occur in other terminals, in a multi-input logic cell can be both obtained for a delay library used in a gate-level timing verification.

In the delay time calculation using the delay library thus created, a reference value can be changed depending on whether there is an overlap between transition times in the input terminal of the multi-input logic cell.

The present invention accomplishes a gate-level delay calculation within a realistic time frame that can consider impacts generated from the synchronous transition in the input terminals of the multi-input logic cell.

The present invention can lessen optimism and pessimism involved in the synchronous transition by considering a timing window (TW: time zone where the signal transition possibly occurs in a time axis) in the inputs of the multi-input logic cell.

A delay library creation method according to a first mode of the present invention is a delay library creation method for creating a delay library of a multi-input logic cell having a plurality of input terminals, including steps of:

calculating a synchronous transition delay time in the multi-input logic cell in a state where input signals in all of the plurality of input terminals synchronously transit;

calculating an asynchronous transition delay time in the multi-input logic cell in a state where the input signal in one of the plurality of input terminals transits and the input signal in any other input terminal of the plurality of input terminals is fixed to a power supply or a ground; and

reciting the synchronous transition delay time and the asynchronous transition delay time in the delay library.

According to the delay library creation method, the delay times in the synchronous and asynchronous transitions in one path (path from input terminal to output terminal) in the multi-input logic cell are both registered in the delay library, and one of the delay times can be selectively used in the gate-level delay calculation.

A delay library creation method according to a second mode of the present invention is a delay library creation method for creating a delay library of a multi-input logic cell having a plurality of input terminals, including steps of:

determining if there is a difference between a delay time in the multi-input logic cell in a state where input signals in all but one of the plurality of input terminals are fixed and a delay time in the multi-input logic cell in a state where the input signals in all of the plurality of input terminals synchronously transit, based on connection information of transistors provided in the multi-input logic cell;

determining if the synchronous transition of the input signals in all of the plurality of input terminals impacts on the delay time of the multi-input logic cell, and

calculating a synchronous transition delay time in the multi-input logic cell in the state where the input signals in all of the plurality of input terminals synchronously transit when it is judged that the synchronous transition impacts on the delay time;

calculating an asynchronous transition delay time in the multi-input logic cell in a state where the input signal in one of the plurality of input terminals transits and the input signal in any other input terminal of the plurality of input terminals is fixed to a power supply or a ground; and

reciting the synchronous transition delay time and the asynchronous transition delay time in the delay library.

According to the delay library creation method, calculation of any cell not affected by the synchronous transition can be omitted, and the delay library can be thereby created with a less computational amount than in the first mode.

A delay library creation method according to a third mode of the present invention is a delay library creation method for creating a delay library of a multi-input logic cell having a plurality of input terminals, including steps of:

determining if there is a difference between a delay time in the multi-input logic cell in a state where input signals in all but one of the plurality of input terminals are fixed and a delay time in the multi-input logic cell in a state where the input signals in all of the plurality of input terminals synchronously transit, based on connection information of transistors provided in the multi-input logic cell;

determining if the synchronous transition of the input signals in all of the plurality of input terminals impacts on the delay time of the multi-input logic cell, and calculating a synchronous transition delay time in the multi-input logic cell in the state where the input signals of all of the plurality of input terminals synchronously transit when it is judged that the synchronous transition impacts on the delay time;

repeatedly calculating the delay time in the multi-input logic cell while changing an input transition timing difference between the input signals in the one of the plurality of input terminals and another input terminal until the delay time no longer changes; and

reciting the input transition timing difference and the delay time in the multi-input logic cell corresponding to the input transition timing difference in the delay library after the association.

According to the delay library creation method, the association of the delay times with the input timing difference between the input signals in all of the input terminals in one path of the multi-input logic cell (path from input terminal to output terminal) can be registered in the delay library. As a result, at the time of calculating a gate-level delay time, a delay time that more closely conforms to that of a real operation can be calculated using an appropriate input transition timing difference.

A delay library according to a first mode of the present invention is a delay library of a multi-input logic cell having a plurality of input terminals, wherein the followings are recited:

a synchronous transition delay time in the multi-input logic cell in a state where input signals in all of the plurality of input terminals synchronously transit; and

an asynchronous transition delay time in the multi-input logic cell in a state where the input signal in one of the plurality of input terminals transits and the input signal of any other input terminal of the plurality of input terminals is fixed to a power supply or a ground.

The delay times in the synchronous and asynchronous transitions in one path in the multi-input logic cell are both registered in the delay library according to the present invention. The delay library can be created by the delay library creation method according to the second mode.

A delay library according to a second mode of the present invention is a delay library of a multi-input logic cell having a plurality of input terminals, reciting an input transition timing difference generated between a transition timing of an input signal in one of the plurality of input terminals and a transition timing of an input signal in any other input terminal of the plurality of input terminals, and the delay time in the multi-input logic cell corresponding to the input transition timing difference after the association.

Thus, the delay library can express the dependence of the delay times on the input transition timing difference in one path of the multi-input logic cell. The delay library can be created by the delay library creation method according to the third mode.

A delay calculation method according to a first mode of the present invention is a method for calculating a delay time in a circuit provided with the multi-input logic cell using the delay library according to the second mode, including steps of:

detecting a signal transition timing in each of the input terminals in the multi-input logic cell;

generating a timing window (TW) representing a time zone where the signal transition possibly occurs in a time axis for each of the input signals in the input terminals based on the signal transition timing;

detecting an overlap between the timing windows (TW) of the input signals; and

calculating the delay time of the circuit by selectively using one of the synchronous transition time and asynchronous transition time depending on the overlap between the timing window (TW), wherein

the steps are sequentially repeated.

The delay calculation method enables a delay calculation considering the synchronous transition delay time and the asynchronous transition delay time.

A delay calculation method according to a second mode of the present invention is a method for calculating a delay time in a circuit provided with the multi-input logic cell using the delay library according to the second mode, including steps of:

calculating a maximum delay time and a minimum delay time in the multi-input logic cell based on the synchronous transition delay time and the asynchronous transition delay time in the multi-input logic cell;

implementing a timing verification of the circuit using the maximum delay time and the minimum delay time;

generating a timing window (TW) representing a time zone where the signal transition possibly occurs in a time axis for each of the input signals in the input terminals based on a result of the timing verification; detecting an overlap between the timing windows (TW) of the input signals; and

calculating the delay time of the circuit by selectively using one of the synchronous transition time and asynchronous transition time depending on the overlap between the timing window (TW), wherein

the step of generating the timing window (TW), the step of detecting the overlap between the timing windows (TW) and the step of calculating the delay time of the circuit are sequentially repeated based on a result of the circuit delay time calculation.

The delay calculation method can lessen pessimism resulting from inputting input signals in a synchronous transition state to a plurality of input terminals provided in the multi-input logic cell without overlooking an intrinsic timing error.

A delay calculation method according to a third mode of the present invention is a method for calculating a delay time in a circuit provided with the multi-input logic cell using the delay library according to the second mode, including steps of:

calculating a maximum delay time and a minimum delay time in the multi-input logic cell based on the synchronous transition delay time and the asynchronous transition delay time in the multi-input logic cell;

implementing a timing verification of the circuit using the maximum delay time and the minimum delay time;

detecting a signal path that violates timing constraints required in designing the circuit from among signal paths provided in the circuit based on a result of the timing verification;

generating a timing window (TW) representing a time zone where the signal transition possibly occurs in a time axis for each of the input signals in the input terminals of the multi-input logic cell on the signal path detected as violating the timing constraints;

detecting an overlap between the timing windows (TW) of the input signals; and

calculating the delay time of the circuit by selectively using one of the synchronous transition time and asynchronous transition time depending on the overlap between the timing window (TW), wherein

the step of generating the timing window (TW), the step of detecting the overlap between the timing windows (TW) and the step of calculating the delay time of the circuit are sequentially repeated based on a result of the circuit delay time calculation.

The delay calculation method can, at a higher speed, lessen pessimism resulting from inputting input signals in a synchronous transition state to a plurality of input terminals provided in the multi-input logic cell without overlooking an intrinsic timing error.

A delay calculation method according to a fourth mode of the present invention is a method for calculating a delay time in a circuit provided with the multi-input logic cell using the delay library according to the third mode, including steps of:

detecting a signal transition timing in each of the input terminals in the multi-input logic cell;

generating a timing window (TW) representing a time zone where the signal transition possibly occurs in a time axis for each of the input signals in the input terminals of the multi-input logic cell based on the signal transition timing;

detecting a difference between the input transition timings by checking the timing windows (TW); and

calculating the delay time of the circuit based on the delay time of the multi-input logic cell corresponding to the input transition timing difference, wherein

the steps are sequentially repeated.

According to the delay calculation method, the delay time can be calculated with a great dependence on the input transition timing difference between the input signals in the input terminals of the multi-input logic cell. The calculation method, therefore, can calculate the delay time in a state closer to a real operation compared with the delay calculation method according to the first mode.

A delay calculation method according to a fifth mode of the present invention is a method for calculating a delay time in a circuit provided with the multi-input logic cell using the delay library according to the third mode, including steps of:

calculating a maximum delay time and a minimum delay time in the multi-input logic cell based on the synchronous transition delay time and the asynchronous transition delay time in the multi-input logic cell;

implementing a timing verification of the circuit using the maximum delay time and the minimum delay time;

generating a timing window (TW) representing a time zone where the signal transition possibly occurs in a time axis for each of the input signals in the input terminals of the multi-input logic cell based on a result of the timing verification;

detecting an overlap between the timing windows (TW) of the input signals;

detecting an input transition timing difference in the multi-input logic cell based on the overlap between the timing windows (TW); and

calculating the delay time of the circuit using the delay time corresponding to the input transition timing difference, wherein

the steps are sequentially repeated.

According to the delay calculation method, the delay time can be calculated with a great dependence on the input transition timing difference between the input signals in the input terminals of the multi-input logic cell. The calculation method, therefore, can calculate the delay time in a state closer to a real operation compared with the delay calculation method according to the second mode.

A delay calculation method according to a fifth mode of the present invention is a method for calculating a delay time in a circuit provided with the multi-input logic cell using the delay library according to the third mode, including steps of:

calculating a maximum delay time and a minimum delay time in the multi-input logic cell based on the synchronous transition delay time and the asynchronous transition delay time in the multi-input logic cell;

implementing a timing verification of the circuit using the maximum delay time and the minimum delay time;

detecting a signal path that violates timing constraints required in designing the circuit from among signal paths provided in the circuit based on a result of the timing verification;

detecting a signal transition timing in each of the input terminals in the multi-input logic cell included in the detected signal path;

generating a timing window (TW) representing a time zone where the signal transition possibly occurs in a time axis for each of the input signals in the input terminals of the multi-input logic cell based on the signal transition timing;

detecting a difference between the input transition timings by checking the timing windows (TW); and

calculating the delay time of the circuit using the delay time of the multi-input logic circuit corresponding to the input transition timing difference, wherein

the steps are sequentially repeated.

According to the delay calculation method, the delay time can be calculated with a great dependence on the input transition timing difference between the input signals of the input terminals in the multi-input logic cell. The calculation method, therefore, can calculate the delay time in a state closer to a real operation compared with the delay calculation method according to the third mode.

### EFFECT OF THE INVENTION

The present invention enables a gate-level timing verification and a gate-level delay time calculation in a multi-input logic cell considering the difference of cell delay times depending on whether input signals of input terminals transit or do not transit synchronously. The advantages thereby obtained are; optimism and pessimism in the timing verification can be lessened, and impacts of the synchronous transition on a real operation of the multi-input terminal can be precisely removed with consideration given to the timing window (TW) in input terminals of the multi-input logic cell.

### BRIEF DESCRIPTION OF THE DRAWINGS

FIG. 1 illustrates input data for delay calculation and a data processing flow.

FIG. 2A is a first drawing illustrating a relationship between signal input timings in input terminals and outputs in a multi-input logic cell.

FIG. 2B is a second drawing illustrating a relationship between signal input timings in input terminals and outputs in the multi-input logic cell.

FIG. 3 is a drawing illustrating a relationship between information necessary for creating a delay library and values in the delay library.

FIG. 4A is a circuit diagram illustrating a first configuration of the multi-input logic cell.

FIG. 4B is an illustration of overlap between timing windows (TW) in input terminals of the multi-input logic cell illustrated in FIG. 4A.

FIG. 5 is an illustration of a delay calculation flow considering a synchronous transition in the multi-input logic cell.

FIG. 6A is a circuit diagram illustrating a second configuration of the multi-input logic cell.

FIG. 6B is an illustration of output signals in a synchronous transition and an asynchronous transition and timing windows (TW) in input terminals of the multi-input logic cell illustrated in FIG. 6A.

FIG. 7 is an illustration of a delay calculation flow considering a synchronous transition in the multi-input logic cell.

FIG. 8 is an illustration of a delay calculation flow considering a synchronous transition in the multi-input logic cell I.

FIG. 9A is an illustration of a first delay library in which delay values obtained in both synchronous and asynchronous transitions in the input terminals of the multi-input logic cell are registered.

FIG. 9B is an illustration of a second delay library in which delay values obtained in synchronous and both asynchronous transitions in the input terminals of the multi-input logic cell are registered.

FIG. 10 is a first characterizing flow considering a synchronous transition in the multi-input logic cell.

FIG. 11 is a second characterizing flow considering a synchronous transition in the multi-input logic cell.

FIG. 12 is a third characterizing flow considering a synchronous transition in the multi-input logic cell.

FIG. 13 is a first delay calculation flow considering a synchronous transition in the multi-input logic cell.

FIG. 14 is a second delay calculation flow considering a synchronous transition in the multi-input logic cell.

FIG. 15 is a third delay calculation flow considering a synchronous transition in the multi-input logic cell.

FIG. 16 is a drawing illustrating a relationship between an input transition timing difference and delay times in the multi-input logic cell.

FIG. 17A is a circuit diagram illustrating a configuration of an NAND circuit which is an example of the multi-input logic cell.

FIG. 17B is a first drawing illustrating a difference between delay times obtained in synchronous and asynchronous transitions in the multi-input logic cell illustrated in FIG. 17A.

FIG. 17C is a second drawing illustrating a difference between delay times obtained in synchronous transition and asynchronous transition in the multi-input logic cell illustrated in FIG. 17A.

FIG. 18 illustrates a hardware apparatus for delay library creation and delay calculation according to preferred embodiments of the present invention.

### DESCRIPTION OF REFERENCE SYMBOLS

102-109
gate-level delay calculation steps, gate-level timing verification steps, and input data
a-1, a-2, b-1, and b-2
signal input timings in input terminals of two-input cell
501-507, 601-607, 701-707, 1303-1307, 1401-1407, and 1501-1507
steps of delay calculation flow considering synchronous transition in multi-input logic cell
801-804, 811-814, and 821-824
steps of delay library characterizing flow considering synchronous transition in multi-input logic cell

### BEST MODE FOR CARRYING OUT THE PRESENT INVENTION

### Preferred Embodiment 1

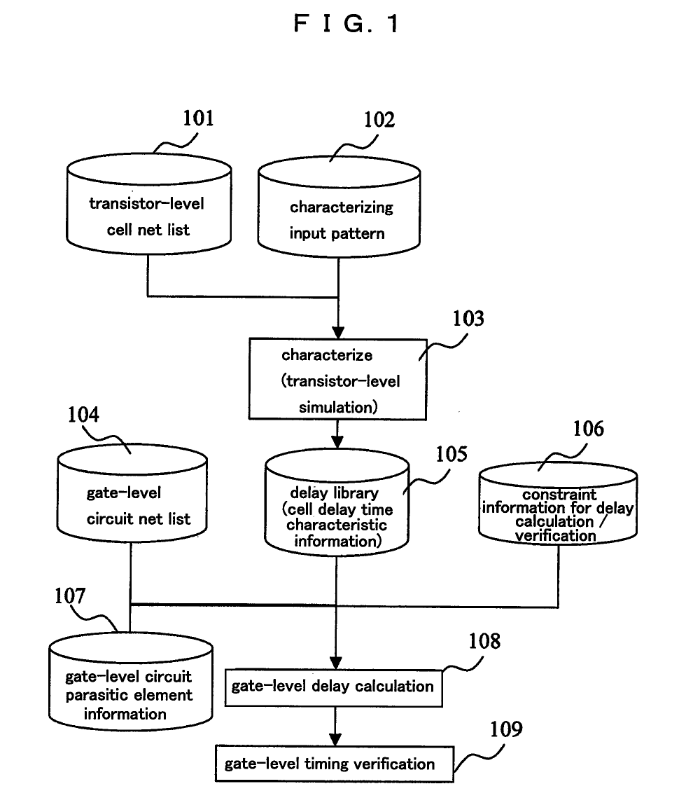

FIG. 1 is a flow chart illustrating a delay library creation method, circuit delay time calculation steps, and input and output data according to a preferred embodiment 1 of the present invention.

First, processing steps for creating a delay library and calculating a gate-level delay time according to the present preferred embodiment are schematically described.

To characterize a signal, a transistor-level cell net list (101) and a characterizing input pattern (102) are inputted so that a transistor-level simulation is carried out (103). A result of the transistor-level simulation (103) (a group of cell delay times) is registered in a delay library (105) in the form of a cell delay time table.

Then, a gate-level delay time calculation (108) is carried out. In the gate-level delay time calculation (108), the delay library (105), a gate-level circuit parasitic element information (107) in which inter-gate wiring capacitance and resistance values are recited, and constraint information (106) for delay calculation/verification are inputted to carry out the calculation. The delay library (105) includes a gate-level circuit net list (104) such as a verilog net list, and an output result of the transistor-level simulation (103). Then, a gate-level timing verification (109) is carried out based on a result of the gate-level delay calculation (108).

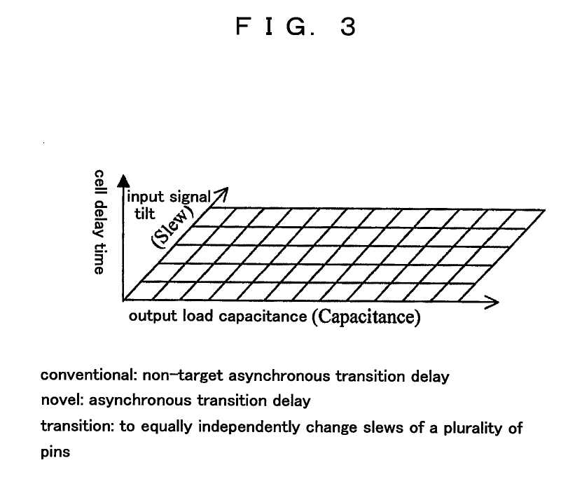

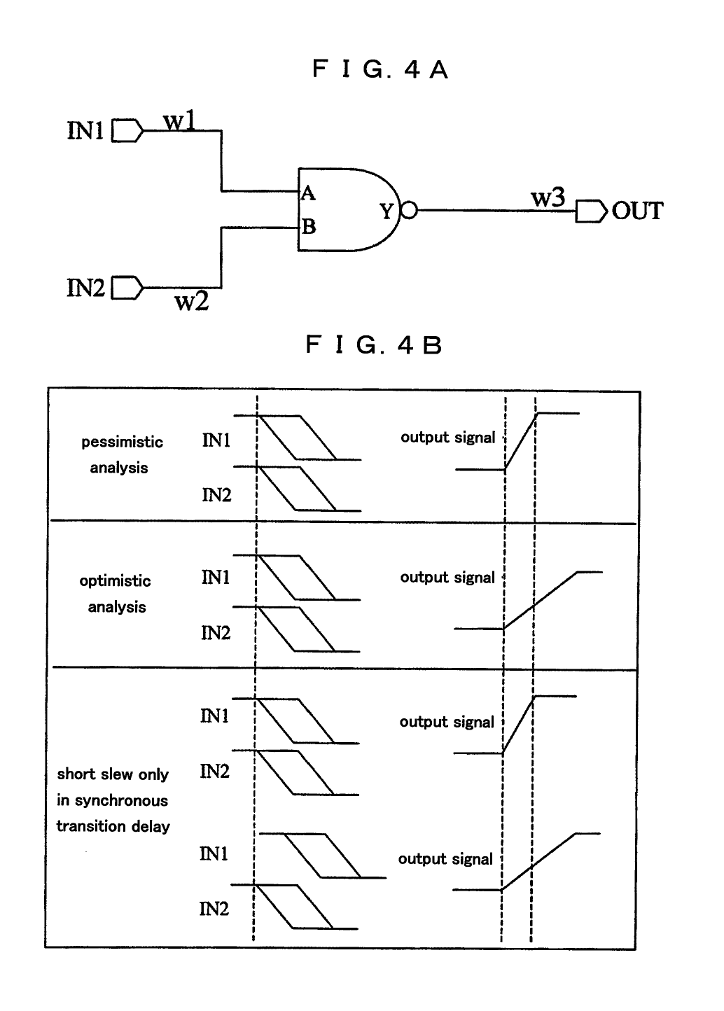

Next, the delay library creating method is described. As is the case with a conventional characterizing process, the transistor-level cell net list (101) is inputted to characterize the delay library. To characterize the delay library, as illustrated in FIG. 3, a characterizing input pattern is generated by changing cell input requirements (input signal tilt and output load capacitance of cell) to calculate a group of cell delay times, and a database containing the tabulated group of cell delay times is registered in the delay library. To characterize the delay library depends on an input transition timing difference between a plurality of input terminals of a multi-input logic cell. In this process, input patterns having different cell delay times are extracted and registered as the characterizing input pattern (102). In the present preferred embodiment, input signal tilts in the plurality of input terminals in the multi-input logic cell are equally fluctuated; however, they may be independently fluctuated.

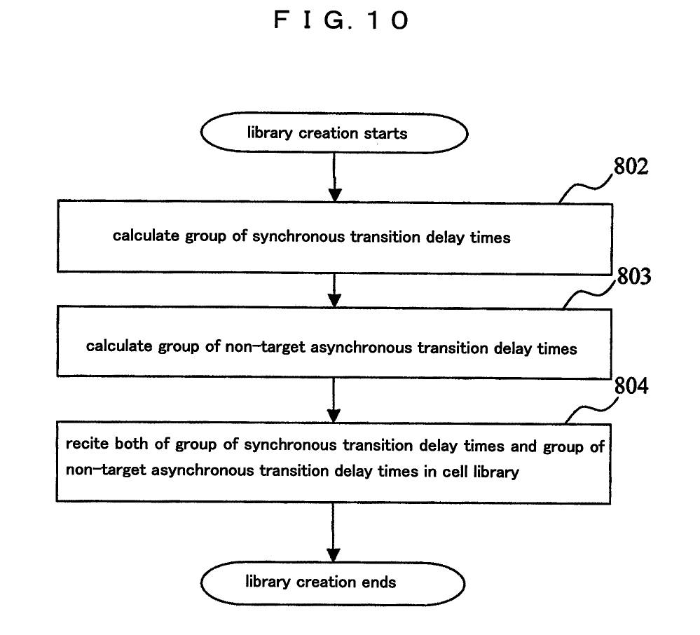

Referring to FIG. 10, the delay library creation method is described in further detail. First, in Step 802, cell delay times in the multi-input logic cell in a state where the input signals of the plurality of input terminals synchronously transit are calculated with tilts of the input signals and output load capacitances in the cell successively changed. The cell delay time is a delay time generated between an input signal inputted to an input terminal as a characterizing target and an output signal outputted from an output terminal in the multi-input logic cell during signal propagation between an input terminal to be characterized and an output terminal (delay time generated in the multi-input logic cell). In the description below, the cell delay time in the multi-input logic cell in the state where the input signals of the plurality of input terminals synchronously transit is called a synchronous transition delay time, and a group of the synchronous transition delay times respectively calculated while tilts of the input signals and output load capacitances in the cell are successively changed are called a group of synchronous transition delay times.

The cell delay time changes under the impact of an input signal inputted to a non-characterizing input terminal. In Step S803, the cell delay time in a state where the input signal of an input terminal to be characterized alone transits but the input signal of a non-characterizing input terminal is fixed to a power supply or a ground is called a non-target fixed asynchronous transition delay time, and a group of the cell delay times respectively calculated while tilts of the input signals and output load capacitances in the cell are successively changed are called a group of non-target fixed asynchronous transition delay times. In the present preferred embodiment, both of the group of synchronous transition delay times and the group of non-target fixed asynchronous transition delay times are calculated. Finally, in Step 814, the group of synchronous transition delay times calculated in Step 812 and the group of non-target fixed asynchronous transition delay times calculated in Step 813 are both associated with characteristic values of the cell and tabulated, and then recited in the delay library 105. The tabulated group of synchronous transition delay times is called a synchronous transition delay time table, and the tabulated group of non-target fixed asynchronous transition delay times is called a non-target fixed asynchronous transition delay time table. Steps 802 and Step 803 may be carried out in the reversed order.

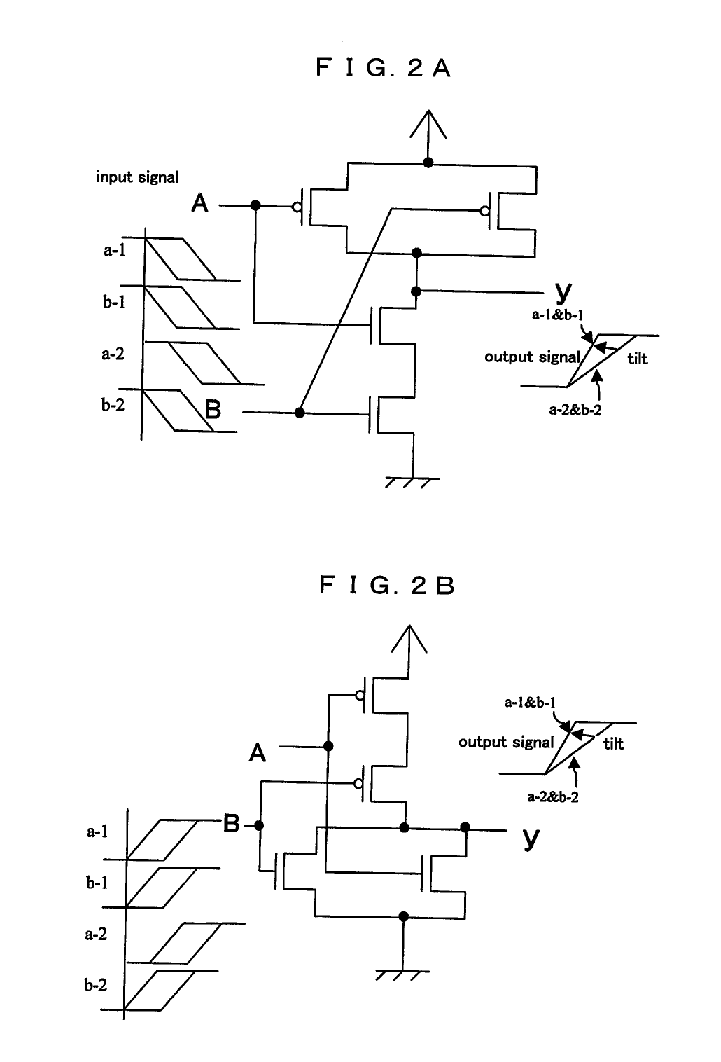

A method for creating a synchronous transition delay time table (minimum delay time of the cell), and a non-target fixed asynchronous transition delay time table (maximum delay time of the cell) is specifically described referring to a 2-input NAND illustrated in FIG. 2A. In the 2-input NAND, P-ch transistors are arranged in parallel, wherein a delay time in the rise of an output signal (cell delay time) differs between the case when input signals in all of the input terminals synchronously transit and the case when the input signal of the input terminal to be characterized alone selectively transits. Therefore, characterizing input patterns (pattern a-1, pattern b-1), in which the input signal is inputted to an input terminal B (non-characterizing input terminal) by a timing synchronous with the input of the input signal to an input terminal A (input terminal to be characterized), are registered as the characterizing input pattern 102, and then, the group of cell delay times are calculated. The group of cell delay times thus calculated is a group of synchronous transition delay times. When the patterns are registered as the characterizing input pattern 102, of an input waveform corruptions in the input terminal B (non-characterizing input terminal), the input waveform corruption where the delay time from the input terminal A (input terminal to be characterized) to an output terminal Y (cell delay time) is minimized, is selected.

Next, characterizing patterns (pattern a-2, pattern b-2), in which an input signal is inputted to the input terminal A (input terminal to be characterized) and the input signal of the input terminal B (non-characterizing input terminal) is fixed to the power supply, are registered as the characterizing input pattern 102, and the group of cell delay times is then calculated. The group of cell delay times thus calculated is a group of non-target fixed asynchronous transition delay times. Then, the group of synchronous transition delay times and the group of non-target fixed asynchronous transition delay times are respectively associated with the characteristic values of the cell. As a result, the synchronous transition delay time table and the non-target fixed asynchronous transition delay time table are generated, and these tables are recited in the delay library 105.

The description given so far is similarly applied to a 2-input NOR gate illustrated in FIG. 2B. In the 2-input NOR gate, N-ch transistors are arranged in parallel, wherein a delay time in the fall of an output signal (cell delay time) differs between the case when input signals in all of input terminals synchronously transit and the case when the input signal of the input terminal to be characterized alone selectively transits. The multi-input logic cells having two inputs respectively illustrated in FIGS. 2A-2B are just examples, and the delay value of the signal transmitted from the input terminal to be characterized to the output terminal (cell delay time) may be similarly affected by the signal status of the input signal inputted to the non-characterizing input terminal in multi-input logic cells having more than two inputs such as three inputs and four inputs. In this case as well, characterization is carried out while the input pattern in the non-characterizing input terminal is variously being changed in the characterizing process, and the synchronous transition delay time table and the non-target fixed asynchronous transition delay time table are recited in the delay library 105.

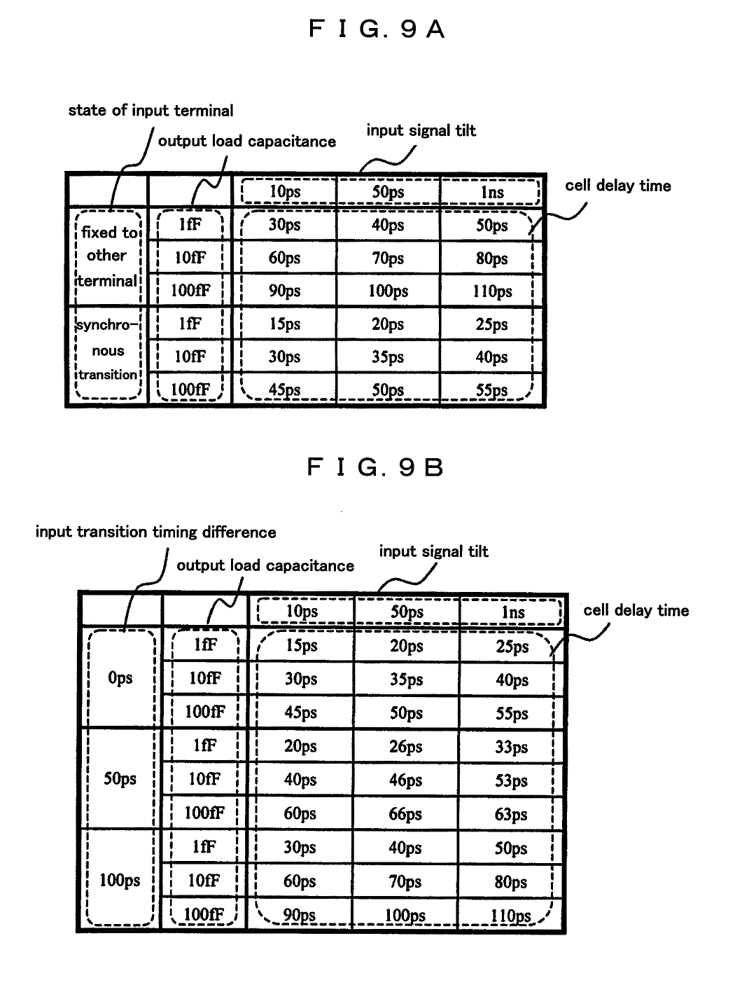

According to the method described so far, the delay library recited in Claim 2 can be created. FIG. 9A illustrates an example of the delay library 105 in which the synchronous transition delay time table and the non-target fixed asynchronous transition delay time table are both registered in the input terminals of the multi-input logic cell. In the delay library according to the prior art, only one of the synchronous transition delay time table and the non-target fixed asynchronous transition delay time table is recited to present pessimistic values. The delay library according to the present preferred embodiment, however, contains both of the synchronous transition delay time table and the non-target fixed asynchronous transition delay time table, allowing one of these tables to be selectively used. When the delay library according to the present preferred embodiment is used (one of the synchronous transition delay time table and the non-target fixed asynchronous transition delay time table can be selectively used), a gate-level delay time that more closely conforms to that of a real operation is obtained in the gate-level delay calculation in Step 108, and a gate-level timing verification can be carried out in Step 109.

### Preferred Embodiment 2

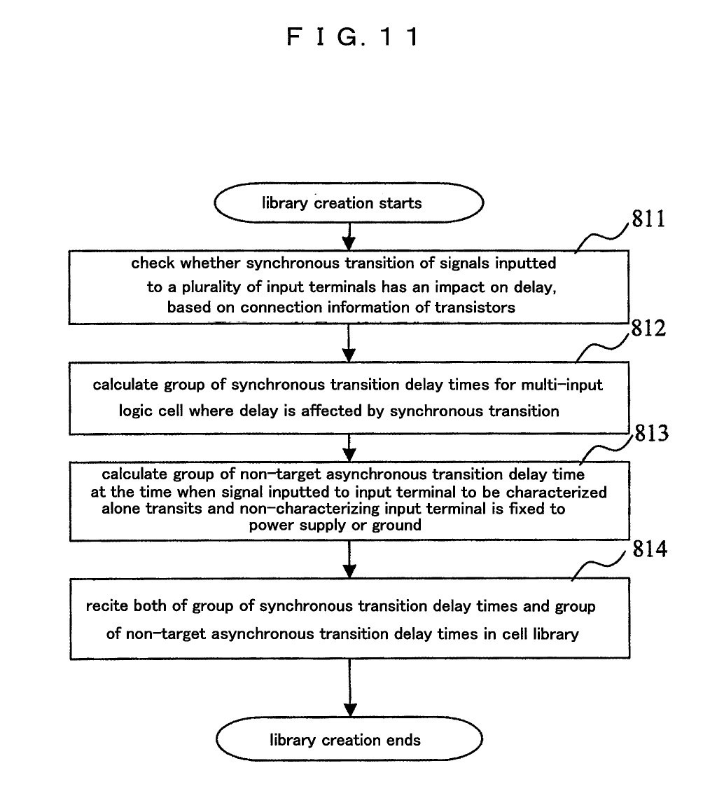

Referring to FIG. 11, a delay library creation method according to a preferred embodiment 2 of the present invention is described. First, in Step 811, it is checked from connection information of transistors in the multi-input logic cell if there is a difference between a non-target fixed asynchronous transition delay time in a state where an input signal inputted to a non-characterizing input terminal in a plurality of input terminals is fixed, and a synchronous transition delay time in a state where input signals in all of the input terminals are in synchronous transition. For example, the rise of an output signal in an NAND cell or the fall of an output signal in an NOR cell is conceived. When the input signals in all of the input terminals synchronously transit in these examples, a larger amount of current flows than in the case of the transition of the input signal in just one input terminal (input terminal to be characterized), increasing an operation speed. It is because the operating transistors operation are parallelly arranged in the cell.

In Step 812, a group of synchronous transition delay times of the multi-input logic cell in which its cell delay times are judged in Step 811 to be affected by the synchronous transition of the input signals in the plurality of input terminals are selectively calculated, and groups of non-target fixed asynchronous transition delay times in all of the multi-input logic cells are also calculated. Then, in Step 814, a synchronous transition delay time table of the multi-input logic cell in which its cell delay time is judged to be affected by the synchronous transition of the input signals in the plurality of input terminals, and non-target fixed asynchronous transition delay time tables in all of the multi-input logic cells are recited in the delay library 105. Just one of the processing step is Step 802 and Step 803 may be implemented for the multi-input logic cell in which its delay is judged not to be affected by the synchronous transition and a result of one of these steps is recied in the delay library 105 as the delay times.

The present preferred embodiment thus enables the omission of the calculation of synchronous transition delay time in the cell not affected by the synchronous transition. As a result, the delay library 105 can be created with a less computational amount.

### Preferred Embodiment 3

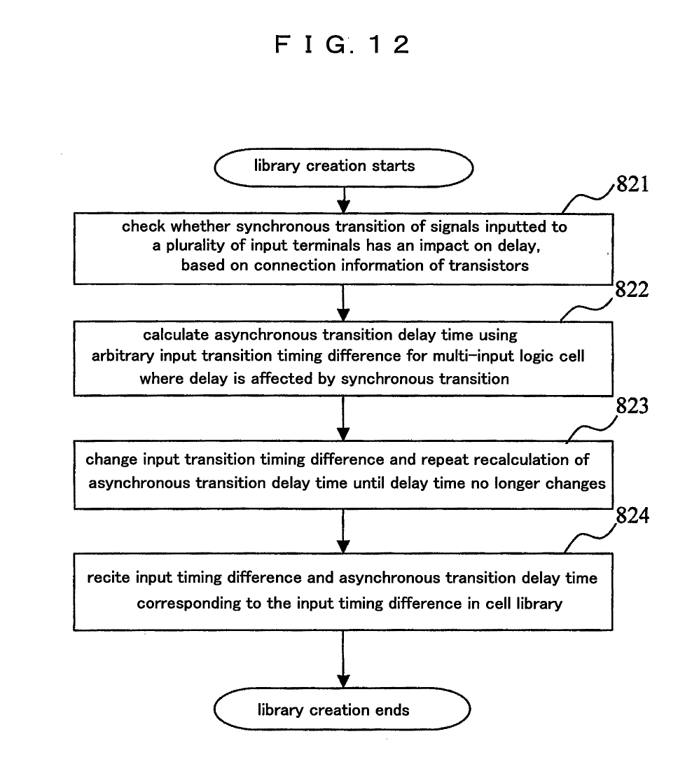

Referring to FIG. 12, a delay library creation method according to a preferred embodiment 3 of the present invention is described. Step 821 is the same as Step 801 illustrated in FIG. 10. In Step 822, a group of synchronous transition delay times in a state where input signals of a plurality of input terminals synchronously transit are calculated concerning a multi-input logic cell in which a cell delay time is affected by the synchronous transition of input signals. In Step 823, input timings of the input signals in the non-characterizing input terminals are changed so that an input transition timing difference is increased, and the synchronous transition delay times are repeatedly calculated. The input transition timing difference used here is a shift between an input signal of an input terminal to be characterized and an input signal of a non-characterizing input terminal. Step 823 is repeatedly carried out until there is no longer any change in the synchronous transition delay times. In Step 824, a synchronous transition delay time table is recited in the delay library 105.

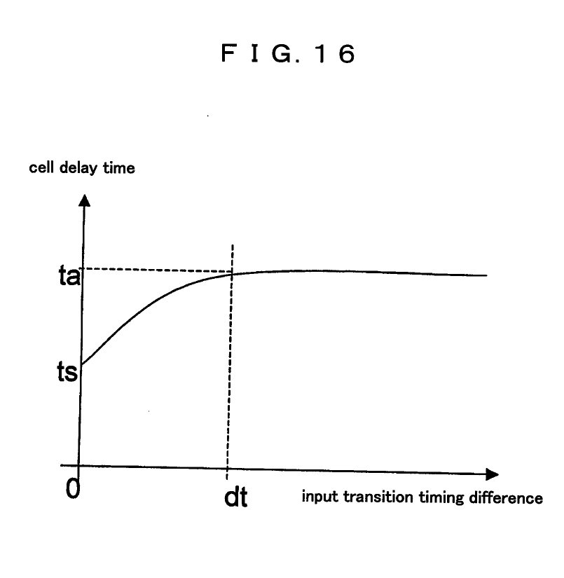

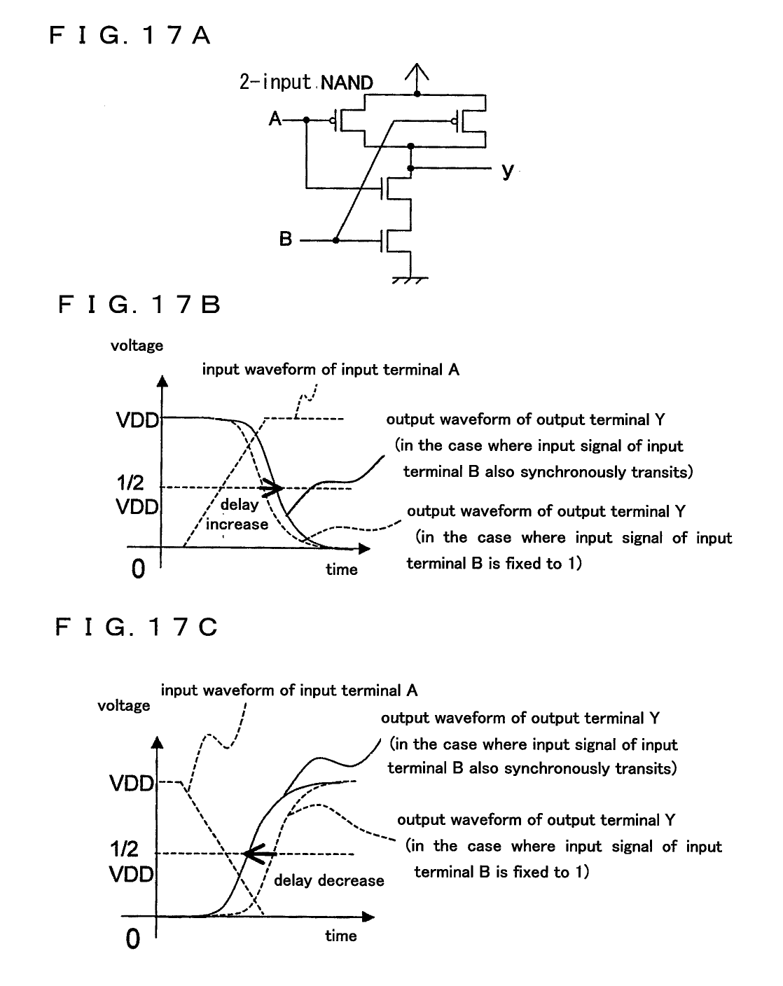

FIG. 16 illustrates a relationship between the input transition timing difference and the cell delay times. A lateral axis denotes the input transition timing difference, and a longitudinal axis denotes the cell delay times. A cell delay time ts is a cell delay time at the time when the input transition timing difference is 0; that is, a synchronous transition delay time. A cell delay time to is a cell delay time when the input transition timing difference is considerably large; that is, an asynchronous transition delay time. dt denotes an input transition timing difference at which the variation of the cell delay times is at most a given value. In the present preferred embodiment, the cell delay times are repeatedly calculated with the input transition timing difference successively changed until the variation of the cell delay times is at most the given value. More specifically, the input transition timing difference is changed from 0 to dt, and the cell times at times during the change are calculated, so that the asynchronous transition delay time table (including the synchronous transition delay time ts and the asynchronous transition delay time dt) is created for each input transition timing difference. In a multi-input logic cell in which an input signal of one input terminal may transit but an output signal of an output terminal does not transit, the input transition timing difference may result in a negative value.

According to the method provided by the present preferred embodiment, the delay library recited in Claim 3 can be created. FIG. 9B illustrates an example of this delay library (the asynchronous transition delay time table is created for each input transition timing difference). In the delay library recited in Claim 2, the non-target fixed asynchronous transition delay time table and the synchronous transition delay time table are both recited, but the asynchronous transition delay time table is not recited for each input transition timing difference. According to the delay library provided by the present preferred embodiment, wherein the asynchronous transition delay time table is recorded for each input transition timing difference, a delay time that more closely conforms to that of a real operation can be calculated and recorded.

### Preferred Embodiment 4

Below is described a gate-level delay time calculation method according to a preferred embodiment 4 of the present invention. The method according to the present preferred embodiment executes a processing flow similar to the gate-level delay time calculation flow according to the preferred embodiment 1 in most of the steps but in the delay library (105) and the gate-level delay time calculation (108).

Conventionally, only a cell delay time table (delay time characteristic information) based on a predetermined single input signal pattern was registered in the delay library (105). Examples of the predetermined single input signal pattern are:
input pattern in a state where an input signal of a non-characterizing input terminal is fixed to “0” or “1”; and
input pattern in a state where the transition of the input signal of the non-characterizing input terminal is synchronous with the transition of an input signal of an input terminal to be characterized.

In a presumed delay library concerning the signal propagation from the input terminal A to the output terminal Y in the 2-input NAND illustrated in FIG. 2A (cell delay time table), an input pattern with the input signal of the non-characterizing input terminal (input terminal B) being fixed to “1” is used as the former example, while an input pattern with the transition of the input signal of the non-characterizing input terminal (input terminal B) synchronizing with the transition of the input signal of the input terminal A is used as the latter example.

In the delay library (delay time characteristic information) 105 according to the present preferred embodiment, cell delay time tables in these two input patterns are both registered as the cell delay time table of the multi-input logic cell. More specifically, the following two cell delay time tables are registered in the delay library (delay time characteristic information) 105.
synchronous transition delay time table
non-target fixed asynchronous transition delay time table

The synchronous transition delay time table is a tabulated database in which cell delay times in a state where an input signal of an input terminal to be characterized transits in synchronization with the transition of an input signal of a non-characterizing input terminal are associated with cell characteristic values. The cell delay times in this state are minimized.

The non-target fixed asynchronous transition delay time table is a tabulated database in which cell delay times in a state where the input signal of the non-characterizing input terminal is fixed are associated with the cell characteristic values. The cell delay times in this state are maximized.

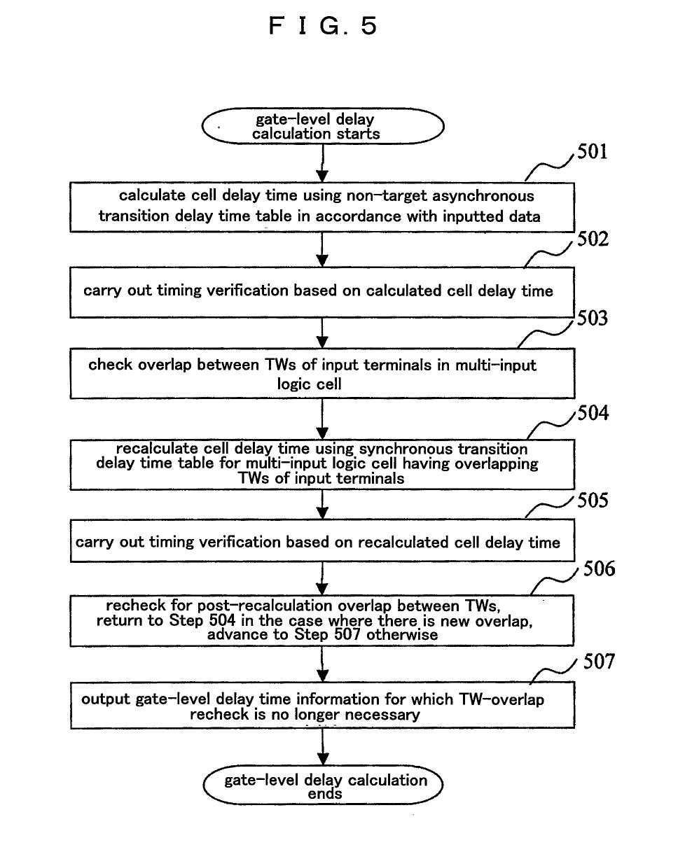

Referring to a flow chart illustrated in FIG. 5, are described in detail processing steps for calculating the gate-level delay time according to the present preferred embodiment. In Step 501, the cell delay times are calculated by using the non-target fixed asynchronous transition delay time table or the synchronous transition delay time table in accordance with inputted data. In Step 502, the gate-level delay time is calculated based on the cell delay times calculated in Step 501 and wiring-related delay times, and a gate-level timing verification based on the calculated gate-level delay time is carried out. In Step 503, a timing window (TW) is generated for each input terminal of the multi-input logic cell based on a result of the gate-level timing verification carried out in Step 502, and it is checked if there is an overlap between the timing windows (TW) (if there is any input transition timing difference). The timing window used here represents a time zone in which a signal transition may possibly occur in a time axis.

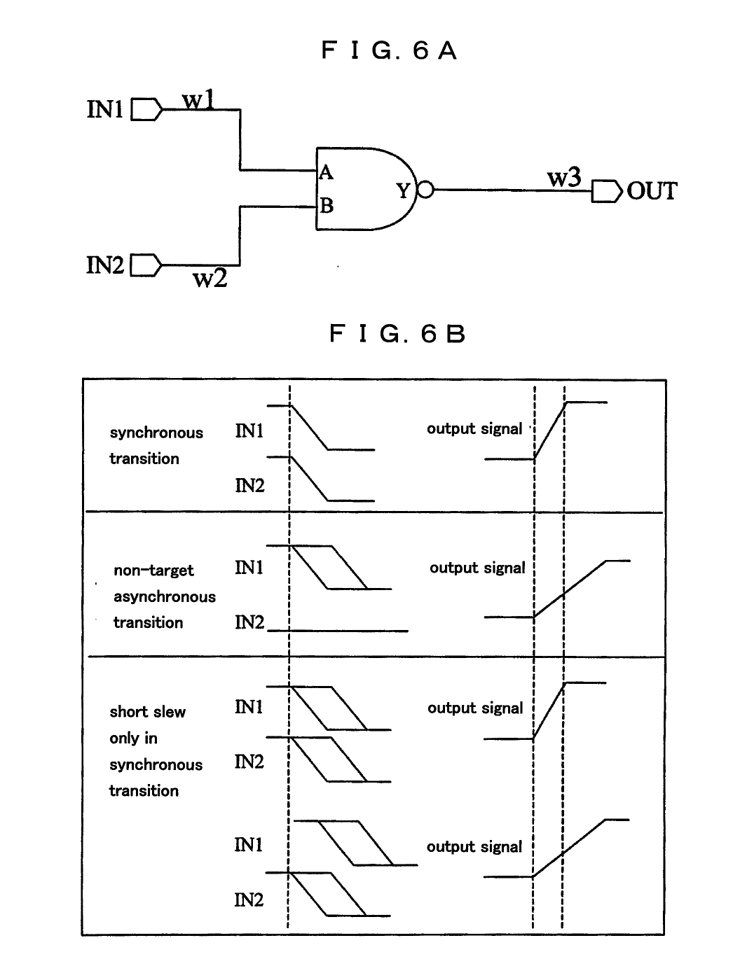

The generation of the timing window (TW) in Step 503 is described referring to FIGS. 6A and 6B. FIG. 6A illustrates a 2-input NAND which is an example of the multi-input logic cell. FIG. 6B illustrates output signals in synchronous and asynchronous transitions in the multi-input logic cell and timing windows (TW) of the input terminals.

Ports and nets connected to the input terminals A and B of the multi-input logic cell are respectively called IN1, IN2, w1 and w3, and a port and a net connected to the output terminal of the multi-input logic cell are respectively called w3, out. Then, as illustrated in FIG. 6B,
the output signal has a least corruption in a state where an input signal of the port IN1 and an input signal of the port IN2 synchronously transit (synchronous transition), and
the output signal has a largest corruption in a state where the input signal of the port IN1 and the input signal of the port IN2 do not synchronously transit (for example, non-target fixed asynchronous transition).

After the processing step in Step 503 is completed, Step 504 recalculates the cell delay times in the multi-input logic cell having the overlapping timing windows (TW) (no input transition timing difference) by using the synchronous transition delay time table of the delay library 105. More specifically, in the case where the timing window (TW) of the port IN1 overlaps with the timing window (TW) of the port IN2 (no input transition timing difference) as illustrated in the 2-input NAND of FIG. 6A, the synchronous transition delay time table of the delay library 105 is selected, and the cell delay times are recalculated based on the selected table. Then, the recalculated values are registered as the cell delay times. With no overlap between the timing windows (TW) (input transition timing difference is generated), the cell delay times are not updated.

Step 505 carries out the gate-level delay time calculation and the gate-level timing verification based on the cell delay characteristic information overwritten in Step 504. Step 506 generates the timing windows (TW) again based on a result of the gate-level timing verification in Step 505 and checks if the timing windows (TW) in the input terminals of the multi-input logic cell are overlapping each other. In the case where it is known from the check of Step 506 that a new overlap is generated between the timing windows (TW) (input transition timing difference is generated), the processing returns to Step 504. In the case where there is no overlap (no input transition timing difference), the processing returns to Step 507. As a final processing step, Step 507 checks again if there is the timing windows (TW) are overlapping each other. When it is confirmed in Step 507 that there is no overlap, the gate-level delay time is outputted. Then, the gate-level delay time calculation ends.

### Preferred Embodiment 5

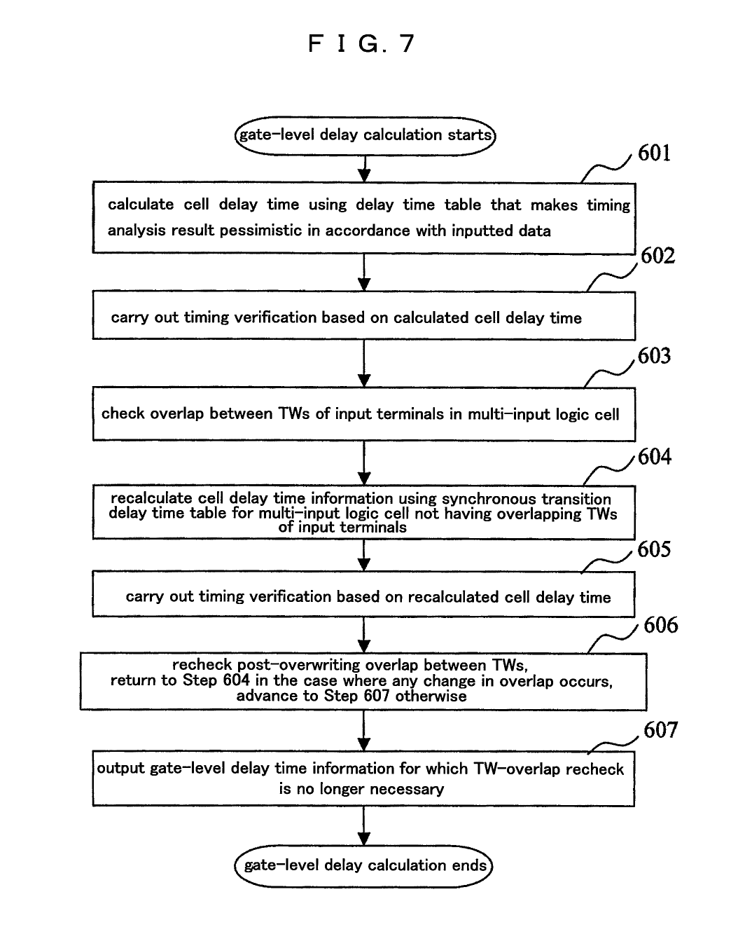

Referring to FIG. 7, a method for calculating a gate-level delay time according to a preferred embodiment 5 of the present invention is described. The present preferred embodiment takes into account a synchronous transition. According to the preferred embodiment 4, the timing verification disregarding the synchronous transition is carried out once, and the timing verification considering the synchronous transition is then carried out, so that the delay times of the calculation result approximate cell delay times in a real operation. In the preferred embodiment 4, however, the delay calculation result finally obtained may tend to be rather optimistic as compared to the real operation. With this in view, in the present preferred embodiment, a pessimistic timing verification considering the synchronous transition is carried out first, and cell delay times of a cell in which overlapping timing windows (TW) (input transition timing difference is generated) is found during the timing verification are calculated such that the pessimism due to the synchronous transition is excluded. Below is given a detailed description.

In Step 601, cell delay times are calculated by using a synchronous transition delay time table or a non-target fixed asynchronous transition delay time table in accordance with inputted data. In the calculation, the delay time table corresponding to an input signal transition leading to a pessimistic timing verification result is selected. In Step 602, a gate-level delay time is calculated based on the cell delay times calculated in Step 601, and a gate-level timing verification based on the calculated gate-level delay time is carried out. A signal transition timing in each input terminal of the multi-input logic cell is known from the processing of Step 602. In Step 603, it is checked if there is an overlap of timing windows (TW) between the input terminals of the multi-input logic cell based on the information obtained in Step 602. In Step 604, the cell delay times of the multi-input logic cell determined in Step 603 as having no overlapping timing windows (TW) between the input terminals (no input transition timing difference) are recalculated based on the synchronous transition delay time table. In Step 605, the gate-level delay time is recalculated based on the cell delay time information recalculated in Step 604, and the gate-level timing verification is carried out based on the gate-level delay time. In Step 606, it is checked if any change occurs in the overlap of the timing windows (TW) overwritten in Step 604. If any change in the overlap of the timing windows (TW) is found in Step 606, the processing returns to Step 604. If no change is found, the processing advances to Step 607 to output the gate-level delay time for which the recheck of overlapping timing windows (TW) is no longer necessary.

### Preferred Embodiment 6

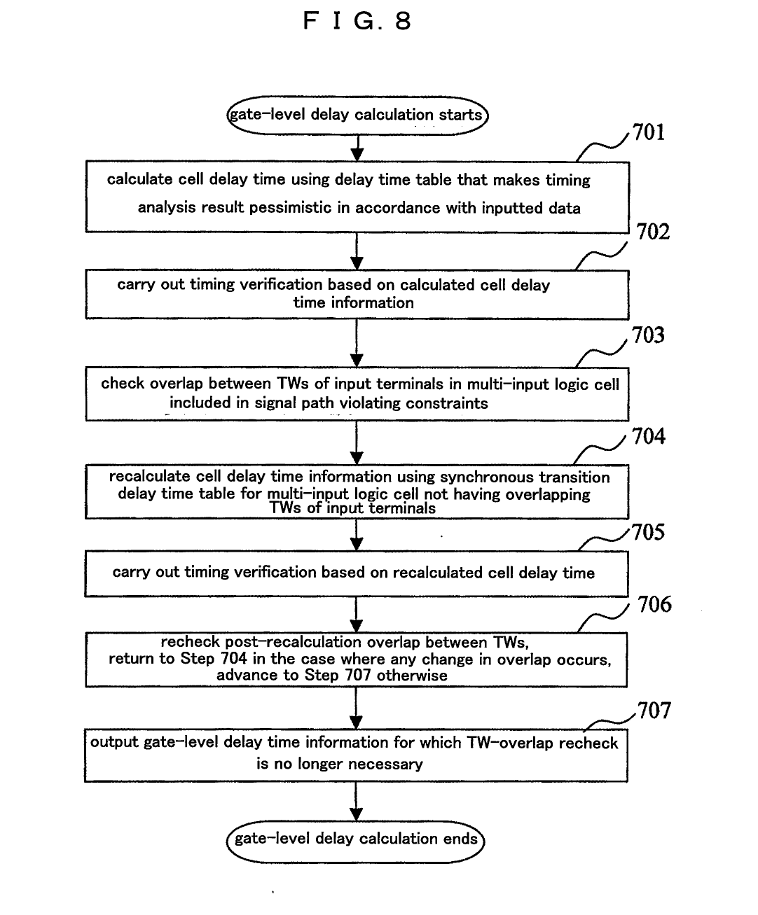

Referring to FIG. 8, a method for calculating a gate-level delay time according to a preferred embodiment 6 of the present invention is described. The present preferred embodiment takes into account synchronous transition. According to the preferred embodiment 5, the overlap of the timing windows (TW) is checked in all paths. However, it is unnecessary to accurately analyze any path meeting timing constraints in a circuit design by bringing its delay times close to those in an actual operation, and the check of the overlapping windows (TW) needs to be made only for a multi-input logic cell on a path where errors occur. In this perspective, the present preferred embodiment checks for the overlap of the timing windows (TW) in a limited number of multi-input logic cells to reduce a computational load. Below is given a detailed description.

In Step 701, cell delay times are calculated by using a synchronous transition delay time table or a non-target fixed asynchronous transition delay time table in accordance with inputted data. In the calculation, the delay time table corresponding to an input signal transition leading to a pessimistic timing verification result is selected. In Step 702, a gate-level delay time is calculated based on the cell delay time information calculated in Step 701, and a gate-level timing verification based on the calculated gate-level delay time is carried out. A signal transition timing of each input terminal in the multi-input logic cell is known from the processing of Step 702. In Step 703, it is selectively checked if there is an overlap between timing windows (TW) of the input terminals in the multi-input logic cell included in a signal path violating timing constraints in a circuit design, based on the information obtained in Step 702. an overlap between timing windows (TW) of the input terminals of any multi-input logic cell included in a signal path compliant with the timing constraints in the circuit design is not checked, which leads to reduction of a computational load. In Step 704, the cell delay times of the multi-input logic cell detected as having no overlapping timing windows (TW) (no input transition timing difference) in Step 703 are recalculated based on the synchronous transition delay time table. In Step 705, the gate-level delay time is recalculated based on the cell delay time information recalculated in Step 704, and the gate-level timing verification is carried out based on the gate-level delay time thus obtained. In Step 706, it is checked if any change occurs in the overlap between the timing windows (TW) updated in Step 704. If a change in the overlap between the timing windows (TW) is found in Step 706, the processing returns to Step 704. If no change is found, the processing advances to Step 707 to output the gate-level delay times for which the recheck of the overlapping timing windows (TW) is no longer necessary.

### Preferred Embodiment 7

A method for calculating a gate-level delay time according to a preferred embodiment 7 of the present invention is described. The present preferred embodiment takes into account synchronous transition. The present preferred embodiment is similar to the preferred embodiment 4 except differences in the following steps:
delay library (cell delay time characteristic information) (105)
gate-level delay time calculation (108)

Below are described a delay library (cell delay time characteristic information) (105) and a gate-level delay time calculation (108) according to the present preferred embodiment. In the delay library according to the preferred embodiment 1, characteristics in a single input signal pattern previously decided (synchronous transition delay time table and non-target fixed asynchronous transition delay time table) are registered in the delay library (cell delay time characteristic information) (105) as illustrated in FIG. 9A. The single input signal pattern previously set used here means the following two types of input signal patters:
input signal pattern in a state where an input signal of a non-characterizing input terminal is fixed to “0” or “1”; and
input signal pattern in a state where the transition of the input signal of the non-characterizing input terminal is synchronous with the transition of an input signal of an input terminal to be characterized.

In the case of the delay library (delay time characteristic information) (105) from the terminal A to the output terminal Y in the 2-input NAND illustrated in FIG. 2A, the input pattern with the input signal of the input terminal B being fixed to “1” is used as the former example, while the input pattern with the transition of the input signal of the input terminal B synchronizing with the transition of the input signal of the input terminal A is used as the latter example.

In the present preferred embodiment, a delay time table is created for each of a plurality of set input transition timing differences and registered in the delay library (delay time characteristic information) (105) as illustrated in FIG. 9B. In FIG. 9B, the delay time table is created for each of the input transition timing differences 0 ps, 50 ps and 100 ps. The input transition timing difference 0 ps used here denotes the synchronous transition, and the delay time table with the input transition timing difference 0 ps corresponds to the synchronous transition delay time table. The delay time table with the input transition timing difference 100 ps corresponds to the non-target fixed asynchronous transition delay time table.

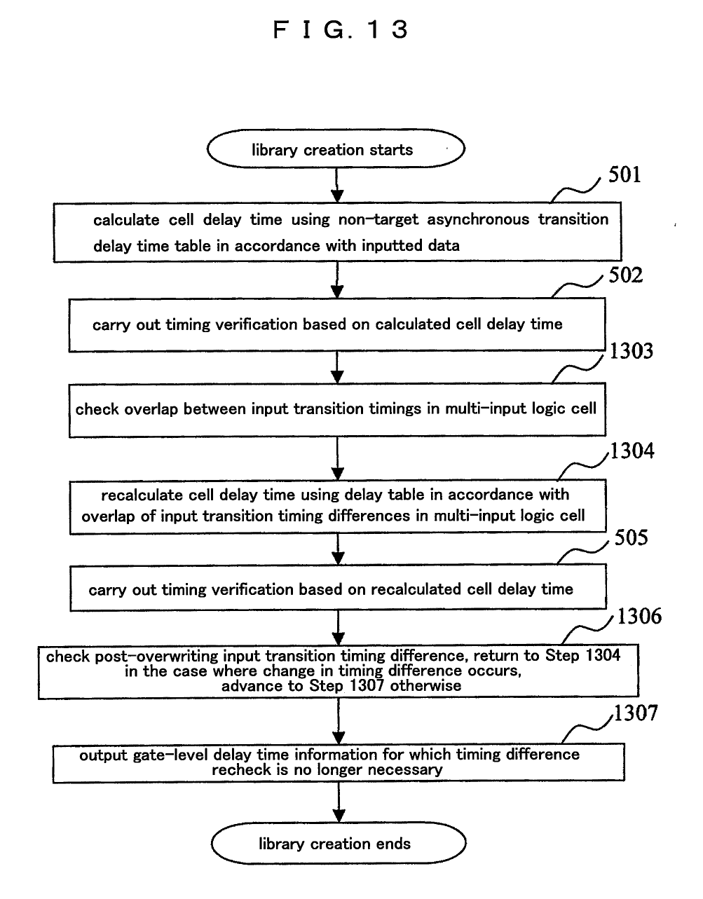

Referring to a flow chart illustrated in FIG. 13, processing steps for calculating a delay time are specifically described. In Step 501, cell delay times are calculated by using one of the delay time tables (any of the delay time tables for the input transition timing differences 0 ps, 50 ps and 100 ps in the example illustrated in FIG. 9B) in accordance with input data. In Step 502, a gate-level delay time is calculated based on the cell delay times (delay values) of the multi-input logic cell calculated in Step 501 and wiring-related delay times (delay values), and a gate-level time verification based on the calculated gate-level delay value is carried out. In Step 1303, timing windows (TW) of input terminals in the multi-input logic cell are generated based on a result of the gate-level timing verification carried out in Step 502, and it is checked if there is an overlap between the generated timing windows (TW) (dimensions of the input transition timing difference).

In Step 1304, the cell delay time characteristic information is overwritten based on the checked overlap between the timing windows (TW). To carry out the step, a delay time table appropriate to the extent of the input transition timing difference between the input terminals is created beforehand and stored in the delay library 105 as illustrated in FIG. 9B. The table is created for each of the input transition timing differences as described earlier. In each table, the cell delay times are associated with output identifiers of the multi-input logic cell. The output identifier of the multi-input logic cell used here is determined based on the combination of an output load capacitance and an output signal tilt in the multi-input logic cell.

In Step 1304, a delay time table is selected based on the checked overlap between the timing windows (TW). Then, the combination of the output load capacitance and the output signal tilt in the multi-input logic cell is checked with the delay time table, and an optimum cell delay time in the multi-input logic cell is extracted from the selected delay time table. The cell delay time information in the delay library is overwritten with the extracted optimum cell delay time.

When there is a certain input transition timing difference equal to or more than a given period of time between the input terminals, an arbitrary delay time may be selected and used without the synchronous transition in the delay library, in which case the cell delay time information is not overwritten.

In the case where the timing windows (TW) are overlapping each other, a delay time table to be selected in the case of the input transition timing difference=0 is a common table, irrespective of the overlap between the timing windows (TW). A common table for the input transition timing difference=0 can reduces a recording capacity required for storing the tables.

In Step 505, the gate-level delay time is calculated based on the cell delay times overwritten in Step 1304, and the gate-level timing verification based on the calculated gate-level delay time is carried out. In Step 1306, the timing windows (TW) are generated again based on a result of the timing verification carried out in Step 505, and then, the input transition timing difference between the input terminals of the multi-input logic cell is checked again. In the case where a difference between the timing windows (TW) (a new overlap) is known from the recheck, the processing returns to Step 1304. The processing advances to Step 1307 with no difference (no new overlap).

As a final step, it is confirmed in Step 1307 that there is no update of the input transition timing difference. With no update, the calculated gate-level delay time is outputted. Then, the gate-level delay calculation ends.

### Preferred Embodiment 8

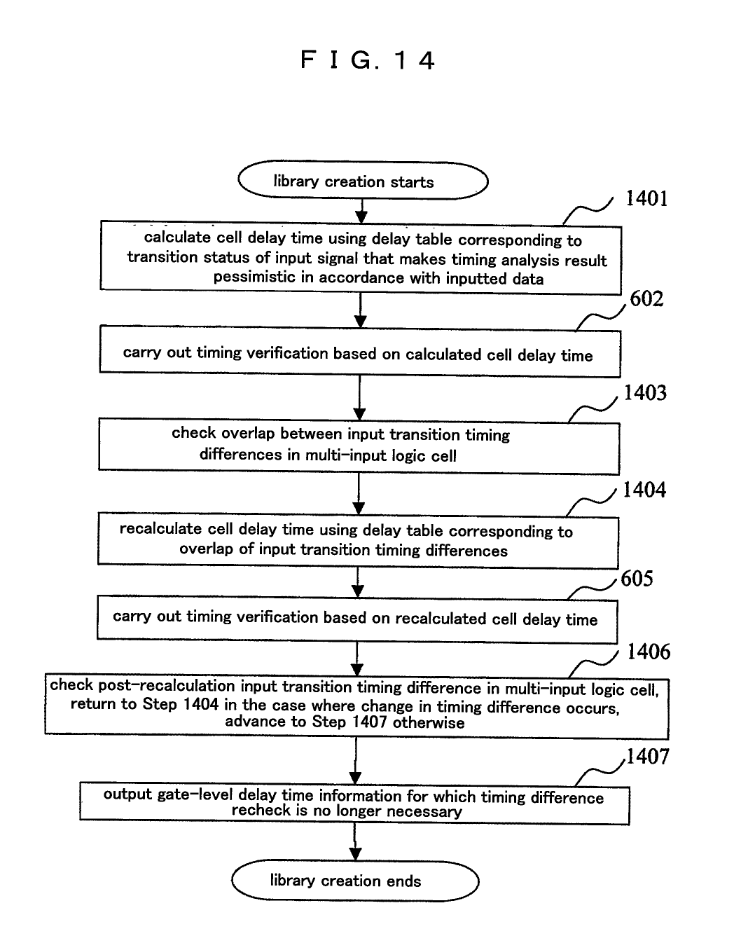

Referring to FIG. 14, a method for calculating a gate-level delay time according to a preferred embodiment 8 of the present invention is described. The present preferred embodiment takes into account synchronous transition. In the preferred embodiment 7, the gate-level timing verification with no regard to the synchronous transition (gate-level delay time calculation) is carried out first, and the gate-level timing verification considering the synchronous transition is then carried out, so that the calculation result can be brought closest to a real operation. The delay calculation result finally obtained in the preferred embodiment 7 tends to be rather optimistic as compared with the real operation. With this in view, in the present preferred embodiment, a pessimistic gate-level timing verification considering the synchronous transition is carried out first, followed by a gate-level timing verification from which any pessimism due to the synchronous transition is removed in any cell detected as having no overlapping timing windows (TW) (input transition timing difference is generated) in the earlier gate-level timing verification. Below is given a detailed description.

In Step S1401 illustrated in FIG. 14, cell delay times are calculated by using an arbitrary delay time table in accordance with inputted data. In the calculation, a delay time table appropriate to an input signal transition that makes the gate-level timing verification pessimistic is selected. In Step 602, a gate-level delay time is calculated based on the cell delay times calculated in Step 1401, and a gate-level timing verification based on the calculated gate-level delay time is carried out. A signal transition timing of each input terminal in the multi-input logic cell is known from the processing of Step 602. In Step 1403, an overlap between timing windows (TW) of the input terminals in the multi-input logic cell is checked based on the information obtained in Step 602. In Step 1404, the cell delay times of any multi-input logic cell detected in Step 1403 as having a small overlap between the timing windows of the input terminals (input transition timing difference is at most a given amount of time) are recalculated based on the delay time table appropriate to the dimensions of the overlap between the timing windows (TW). In Step 605, the gate-level delay time is recalculated based on the cell delay time information recalculated in Step 1404, and the gate-level timing verification is carried out based on recalculated gate-level delay time. In Step 1406, the input transition timing difference after the gate-level delay time information is overwritten in Step 1404 is checked again. When the input transition timing difference is detected during the check in Step 1406, the processing returns to Step 1404. The processing advances to Step 1407 with no input transition timing difference. In Step 1407, the gate-level delay time for which the recheck of the input transition timing difference is no longer necessary is outputted.

### Preferred Embodiment 9

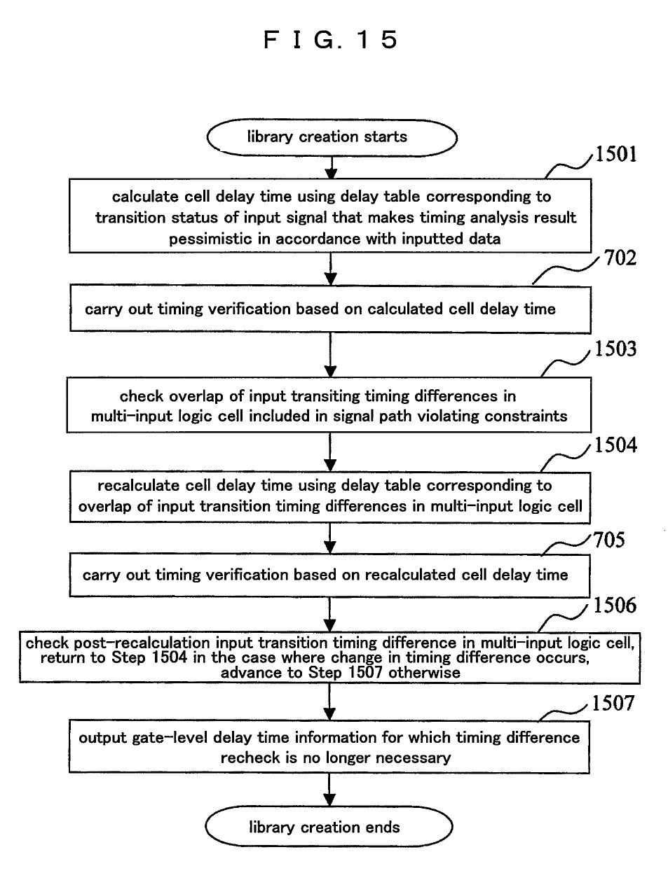

Referring to FIG. 15, a method for calculating a gate-level delay time according to a preferred embodiment 9 of the present invention is described. The present preferred embodiment takes into account synchronous transition. According to the preferred embodiment 8, the overlap between the timing windows (TW) is checked in all paths. However, it is unnecessary to accurately analyze any path meeting timing constraints in a circuit design by bringing its delay times close to those in an actual operation, and the check between the overlapping windows (TW) needs to be made only for a multi-input logic cell on a path where errors occur. In this perspective, the present preferred embodiment checks the overlap between the timing windows (TW) in a limited number of multi-input logic cells to reduce a computational load. Below is given a detailed description.

In Step 1501 illustrated in FIG. 15, cell delay times are calculated by using an arbitrary delay time table in accordance with inputted data. In the calculation, the delay time table corresponding to an input signal transition leading to a pessimistic timing verification result is selected. In Step 702, a gate-level delay time is calculated based on the cell delay time information calculated in Step 1501, and a gate-level timing verification based on the calculated gate-level delay time is carried out. A signal transition timing of each input terminal in the multi-input logic cell is known from the processing of Step 702. In Step 1503, it is checked if there is a difference equal to or larger than a given period of time between timing windows (TW) of the input terminals in the multi-input logic cell included in a signal path violating timing constraints based on the information obtained in Step 702. In Step 1054, the cell delay times of the multi-input logic cell detected in Step 1503 as having the difference equal to or larger than a given period of time (transition timing difference stays within a given period of time) are recalculated based on the delay time table appropriate to the dimensions of the input transition timing difference. In Step 705, the gate-level delay time is recalculated based on the cell delay time information recalculated in Step 1504, and the gate-level timing verification is carried out again based on the gate-level delay time thus obtained. In Step 1506, the input transition timing difference detected in the timing verification carried out again in Step 705 is rechecked. If it is judged during the recheck in Step 1506 that any change in the input transition timing difference occurs, the processing returns to Step 1504. If it is judged that no change occurs, the processing advances to Step 1507 to output the delay information for which the recheck of the input transition timing difference is no longer necessary.

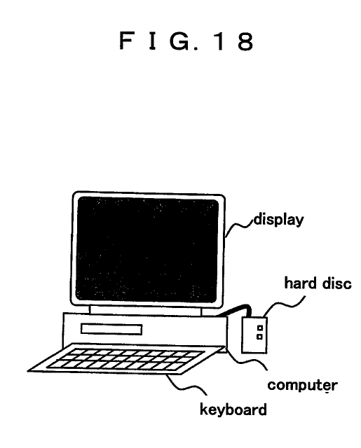

The delay library creation methods and the delay calculation methods according to the preferred embodiments described so far are accomplished by a hardware configuration illustrated in FIG. 18. When a program recorded on a recording medium such as a hard disc or CD-ROM is read from the recording medium by a computer and executed, the delay library creation methods and the delay calculation methods according to the preferred embodiments described so far can accomplished.

### INDUSTRIAL APPLICABILITY

The delay library creation method and the delay calculation method according to the present invention can consider impacts of the variation of cell delay times during the synchronous transition of input signals in input terminals of a multi-input logic cell. These methods, therefore, are useful for the reduction of optimism and pessimism in designing miniaturized elements with a desirably smaller design margin and carrying out a gate-level timing verification.

What is claimed is:

1. A delay library creation method for creating a delay library of a multi-input logic cell comprising a plurality of input terminals, including steps of:
calculating a synchronous transition delay time in the multi-input logic cell in a state where input signals in all of the plurality of input terminals synchronously transit;
calculating an asynchronous transition delay time in the multi-input logic cell in a state where the input signal in one of the plurality of input terminals transits and the input signal in any other input terminal of the plurality of input terminals is fixed to a power supply or a ground; and
reciting the synchronous transition delay time and the asynchronous transition delay time in the delay library.

2. A delay library creation method for creating a delay library of a multi-input logic cell comprising a plurality of input terminals, including steps of:
determining if there is a difference between a delay time in the multi-input logic cell in a state where input signals in all but one of the plurality of input terminals are fixed and a delay time in the multi-input logic cell in a state where the input signals in all of the plurality of input terminals synchronously transit, based on connection information of transistors provided in the multi-input logic cell;
determining if the synchronous transition of the input signals in all of the plurality of input terminals impacts on the delay time of the multi-input logic cell, and calculating a synchronous transition delay time in the multi-input logic cell in the state where the input signals in all of the plurality of input terminals synchronously transit when it is judged that the synchronous transition impacts on the delay time;
calculating an asynchronous transition delay time in the multi-input logic cell in a state where the input signal in one of the plurality of input terminals transits and the input signal in any other input terminal of the plurality of input terminals is fixed to a power supply or a ground; and
reciting the synchronous transition delay time and the asynchronous transition delay time in the delay library.

3. A delay library creation method for creating a delay library of a multi-input logic cell comprising a plurality of input terminals, including steps of:
determining if there is a difference between a delay time in the multi-input logic cell in a state where input signals in all but one of the plurality of input terminals are fixed and a delay time in the multi-input logic cell in a state where the input signals in all of the plurality of input terminals synchronously transit, based on connection information of transistors provided in the multi-input logic cell;
determining if the synchronous transition of the input signals in all of the plurality of input terminals impacts on the delay time of the multi-input logic cell, and calculating a synchronous transition delay time in the multi-input logic cell in the state where the input signals of all of the plurality of input terminals synchronously transit when it is judged that the synchronous transition impacts on the delay time;
repeatedly calculating the delay time in the multi-input logic cell while changing an input transition timing difference between the input signals in the one of the plurality of input terminals and another input terminal until the delay time no longer changes; and
reciting the input transition timing difference and the delay time in the multi-input logic cell corresponding to the input transition timing difference in the delay library after the association.

4. A delay library of a multi-input logic cell comprising a plurality of input terminals, wherein the followings are recited:
a synchronous transition delay time in the multi-input logic cell in a state where input signals in all of the plurality of input terminals synchronously transit; and
an asynchronous transition delay time in the multi-input logic cell in a state where the input signal in one of the plurality of input terminals transits and the input signal of any other input terminal of the plurality of input terminals is fixed to a power supply or a ground.

5. A delay library of a multi-input logic cell comprising a plurality of input terminals, reciting an input transition timing difference generated between a transition timing of an input signal in one of the plurality of input terminals and a transition timing of an input signal in any other input terminal of the plurality of input terminals, and the delay time in the multi-input logic cell corresponding to the input transition timing difference after the association.

6. The delay library as claimed in claim 5, wherein the followings are recited:
a delay time table in which a synchronous transition delay time in the multi-input logic cell in a synchronous transition of the input signals of the plurality of input terminals in the multi-input logic cell corresponding to the transition timing difference is associated with the transition timing difference; and
a delay time table in which an asynchronous transition delay time in the multi-input logic cell in a state where the input signal of one of the plurality of input terminals transits and the input signal of any other input terminal of the plurality of input terminals is fixed to a power supply or a ground is associated with the transition timing difference.

7. A delay calculation method for calculating a delay time in a circuit provided with the multi-input logic cell using the delay library claimed in claim 4, including steps of:
detecting a signal transition timing in each of the input terminals in the multi-input logic cell;
generating a timing window (TW) representing a time zone where the signal transition possibly occurs in a time axis for each of the input signals in the input terminals based on the signal transition timing;
detecting an overlap between the timing windows (TW) of the input signals; and
calculating the delay time of the circuit by selectively using one of the synchronous transition time and asynchronous transition time depending on the overlap between the timing window (TW), wherein
the steps are sequentially repeated.

8. A delay calculation method for calculating a delay time in a circuit provided with the multi-input logic cell using the delay library claimed in claim 4, including steps of:
calculating a maximum delay time and a minimum delay time in the multi-input logic cell based on the synchronous transition delay time and the asynchronous transition delay time in the multi-input logic cell;
implementing a timing verification of the circuit using the maximum delay time and the minimum delay time;
generating a timing window (TW) representing a time zone where the signal transition possibly occurs in a time axis for each of the input signals in the input terminals based on a result of the timing verification;
detecting an overlap between the timing windows (TW) of the input signals; and
calculating the delay time of the circuit by selectively using one of the synchronous transition time and asynchronous transition time depending on the overlap between the timing window (TW), wherein
the step of generating the timing window (TW), the step of detecting the overlap between the timing windows (TW) and the step of calculating the delay time of the circuit are sequentially repeated based on a result of the circuit delay time calculation.

9. A delay calculation method for calculating a delay time in a circuit provided with the multi-input logic cell using the delay library claimed in claim 4, including steps of:
calculating a maximum delay time and a minimum delay time in the multi-input logic cell based on the synchronous transition delay time and the asynchronous transition delay time in the multi-input logic cell;
implementing a timing verification of the circuit using the maximum delay time and the minimum delay time;
detecting a signal path that violates timing constraints required in designing the circuit from among signal paths provided in the circuit based on a result of the timing verification;
generating a timing window (TW) representing a time zone where the signal transition possibly occurs in a time axis for each of the input signals in the input terminals of the multi-input logic cell on the signal path detected as violating the timing constraints;
detecting an overlap between the timing windows (TW) of the input signals; and
calculating the delay time of the circuit by selectively using one of the synchronous transition time and asynchronous transition time depending on the overlap between the timing window (TW), wherein
the step of generating the timing window (TW), the step of detecting the overlap between the timing windows (TW) and the step of calculating the delay time of the circuit are sequentially repeated based on a calculated delay time of the circuit.

10. A delay calculation method for calculating a delay time in a circuit provided with the multi-input logic cell using the delay library claimed in claim 5, including steps of:
detecting a signal transition timing in each of the input terminals in the multi-input logic cell;
generating a timing window (TW) representing a time zone where the signal transition possibly occurs in a time axis for each of the input signals in the input terminals of the multi-input logic cell based on the signal transition timing;
detecting a difference between the input transition timings by checking the timing windows (TW); and
calculating the delay time of the circuit based on the delay time of the multi-input logic cell corresponding to the input transition timing difference, wherein
the steps are sequentially repeated.

11. A delay calculation method for calculating a delay time in a circuit provided with the multi-input logic cell using the delay library claimed in claim 5, including steps of:
calculating a maximum delay time and a minimum delay time in the multi-input logic cell based on the synchronous transition delay time and the asynchronous transition delay time in the multi-input logic cell;
implementing a timing verification of the circuit using the maximum delay time and the minimum delay time;
generating a timing window (TW) representing a time zone where the signal transition possibly occurs in a time axis for each of the input signals in the input terminals of the multi-input logic cell based on a result of the timing verification;
detecting an overlap between the timing windows (TW) of the input signals;
detecting an input transition timing difference in the multi-input logic cell based on the overlap between the timing windows (TW); and
calculating the delay time of the circuit using the delay time corresponding to the input transition timing difference, wherein
the steps are sequentially repeated.

12. A delay calculation method for calculating a delay time in a circuit provided with the multi-input logic cell using the delay library claimed in claim 5, including steps of:
calculating a maximum delay time and a minimum delay time in the multi-input logic cell based on the synchronous transition delay time and the asynchronous transition delay time in the multi-input logic cell;
implementing a timing verification of the circuit using the maximum delay time and the minimum delay time;
detecting a signal path that violates timing constraints required in designing the circuit from among signal paths provided in the circuit based on a result of the timing verification;
detecting a signal transition timing in each of the input terminals in the multi-input logic cell included in the detected signal path;
generating a timing window (TW) representing a time zone where the signal transition possibly occurs in a time axis for each of the input signals in the input terminals of the multi-input logic cell based on the signal transition timing;
detecting a difference between the input transition timings by checking the timing windows (TW); and
calculating the delay time of the circuit using the delay time of the multi-logic cell corresponding to the input transition timing difference, wherein
the steps are sequentially repeated.
